(19) United States
(12) Patent Application Publication
(10) Pub. No.: US 2005/0053709 A1
(43) Pub. Date: Mar. 10, 2005

(54) Method for preparing cooked and pre-cooked crab-based food products

(75) Inventor: Keith J. Fulmer, Grasonville, MD (US)

Correspondence Address: NIXON & VANDERHYE, PC, 1100 N GLEBE ROAD, 8TH FLOOR, ARLINGTON, VA, 22201-4714, US

(73) Assignee: Chesapeake Crab Dawg Co., Inc., Grasonville, MD (US)

(21) Appl. No.: 10/932,233

(22) Filed: Sep. 2, 2004

Related U.S. Application Data
(60) Provisional application No. 60/499,718, filed on Sep. 4, 2003.

(51) Int. Cl. A21D 13/08

(52) U.S. Cl. 426/556

(57) ABSTRACT

A method for preparing a cooked pastry shell food product whereby the pastry shell has a thickness and dough consistency sufficient to encapsulate and hold a crabmeat mixture without danger of scorching or burning the pastry shell during subsequent baking or deep frying operations. The exemplary method of preparation balances the heat transfer characteristics of the pastry shell and the crab meat using a new combination of ingredients for the crabmeat and shell, as well as preparation steps that serve to avoid overcooking either the crab meat or the shell. Products according to the invention can be prepared in uncooked form in advance of the final baking or frying process for refrigeration and possible storage without sacrificing the quality or taste of the final cooked product.

### CROSS-REFERENCE TO RELATED APPLICATION

The present application is based on provisional application Ser. No. 60/499,718, filed Sep. 4, 2003. Applicant hereby claims the benefit of such provisional filing under 35 U.S.C. § 119(e).

### BACKGROUND OF THE INVENTION

The present invention relates to a new crab-based pastry product having particular advantages to restaurants or other entities engaged in preparing, storing or serving seafood products, and to a method for preparing such crab-based pastry products. In particular, the invention involves a new variety of thin-walled pastry products that fully enclose (encapsulate) the crabmeat and can be baked or deep fried either before or after storage, depending on the desired end use application.

In the past, products that include cooked crab meat as one of the main ingredients invariably do not enclose the crab meat within a pastry shell. It is well known that it is extremely difficult to create an acceptable crab-based product with the crab meat positioned on the inside of a cooked pastry shell. Past attempts at making such products often failed because the cooking process adversely effected the taste and texture of the crab meat inside the shell or tended to ruin the taste and appearance of the pastry itself. For example, if the thickness or density of the pastry dough was too high, the amount of heat necessary to effectively cook the crab meat on the inside after initial preparation (thereby allowing the cooked product to be served hot), often resulted in the outside shell becoming scorched or burned, thereby detrimentally effecting the overall taste and appearance of the end product. From the standpoint of heat transfer, the thermal conductivity of certain pastry shells, such as those using thick pizza type dough, tend to be lower due to the consistency and thickness of the dough. Thus, the effective amount of heat transferred to the crab meat is often too low to avoid scorching and/or burning the outside surface of the shell.

In like manner, if the pastry shell dough is too thin or the uncooked consistency of the dough is too low, the amount of heat transferred to the crab meat may be too high, leaving the interior crabmeat overcooked. If the amount of heat is reduced in order to avoid overcooking the interior, the pastry shell may be undercooked, again producing an unacceptable commercial product from the standpoint of taste and appearance.

These inherent problems in enclosing (encapsulating) and then heating crab meat inside a pastry shell can be even more pronounced when the products are cooked initially and preserved for later use after refrigeration and reheating. As a result, in the past, the use of a pastry shell in combination with either cooked or uncooked crab meat, particularly pastry products that fully encapsulate the crab meat, has been virtually non-existent.

### BRIEF SUMMARY OF THE INVENTION

The present invention solves many of the above problems associated with using pastry to encapsulate crab meat and results in a product having a unique taste, appearance and texture such that the crabmeat is fully cooked without resulting in scorching or burning of the outside pastry shell.

In one aspect, the invention balances the heat transfer characteristics of the pastry shell and the crab meat by virtue of the ingredients for both the crabmeat mixture and pastry shell. The invention also includes a new sequence of preparation steps that avoids overcooking either the crab meat or the shell. The preferred method according to the invention allows the products to be prepared in uncooked form in advance of the final baking or frying process for refrigeration and possible storage, again without sacrificing the quality or taste of the final cooked product. The products and method according to the invention also improve the convenience and portability of cooked and uncooked products for consumers, making it easier for restaurants to prepare and deliver the product in an efficient manner with a higher degree of confidence in controlling the quality of the final cooked product.

### DETAILED DESCRIPTION OF THE INVENTION

The basic process steps for preparing and cooking crab-based products according to the invention may be described as follows:

### Exemplary Steps for Preparing Products Prior to Cooking

Step 1—Remove substantially all cartilage from crabmeat after extracting the meat from partially precooked (e.g., boiled) crabs. Prepare a mixture of breadcrumbs, eggs, mayonnaise and seasonings. Add the extracted crabmeat and mix gently, but thoroughly. If the mixture is too dry, add more mayonnaise and then chill the final mixture.

Step 2—Cut one sheet of pastry puff dough into 6 squares. On a flat preparation surface, sprinkle a small amount of corn flour to prevent the pastry dough from sticking to the preparation surface. Roll each square out to a very thin, almost transparent, thickness, i.e., less than about 3/64 inches, and cut each square into halves. The user should now have 12 equally thin pieces from the original sheet of dough, each ranging in thickness between about 1/32 inches and 3/64 inches.

Step 3—Along the middle of one edge of each of the 12 cut pieces, place approximately 3 oz. of the crab mixture as described herein. Shape the mixture into an elongated roll across the middle of one end of the pastry square, leaving approximately 1-1½ inch of pastry on each end.

Step 4—Fold the ends of the pastry over the edges of the crab mixture (thereby effectively preventing the mixture from being squeezed out during rolling). Beginning at the bottom edge closest to the mixture, roll the square up onto the remaining dough forming a log shape.

Step 5—Seal the edges by mixing equal parts 2% milk and table ready pasteurized egg (egg wash) and dabbing a small amount onto the edges of each finished log roll (hereinafter referred to as a “Crab Dawg”™) with a small pastry brush, until secure.

Step 6—Refrigerate the rolled and sealed products over night.

### Exemplary Cooking Steps

Frying Method: Heat peanut oil (or other cooking oil) in a commercial deep fryer to a temperature of about 350 degrees F. Place the completed products in the fry basket. For effective cooking, the completed rolls must lay flat and not on top of one another. Deep fry the rolls until they float to the surface and turn a golden brown (approximately 3 minutes cooking time) or until the inside crabmeat mixture temperature reaches about 160 degrees F.

Baking Method: Pre-Heat a conventional oven to about 400 degrees F. Place the Crab Dawgs™ on a baking sheet and bake for about 18 to 20 minutes or until golden brown. Leave 1″ between Crab Dawgs™ to allow for even cooking.

### Exemplary Uncooked Product Composition

Exemplary ingredients used to form the uncooked crab-based product according to the invention include the following:
5 lbs. U.S. blue claw crab meat
3½ lbs. claw meat, 1½ lbs. backfin meat
1 cup bread crumbs
3 eggs
2¼ cups mayonnaise
2 tbsp. dry mustard
5 tbsp. parsley
5 tsp. Old Bay seasoning
box of pastry puff dough
¼ cup of corn flour (for prep surface)

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for preparing an edible food product containing crabmeat, comprising the steps of:
removing substantially all cartilage from said crabmeat;
combining said cartilage-free crabmeat with an amount of breadcrumbs, eggs, mayonnaise and seasonings sufficient to form a crab mixture having a moist consistency;
preparing a plurality of pastry shells for said crabmeat by rolling uncooked pastry dough into a thin, flat substrate and dividing said thin, flat substrate into individual uncooked dough segments;
placing a portion of said crab mixture on each one of said uncooked dough segments;
forming said crab mixture and uncooked dough segment into an elongated roll;
folding uncooked dough at the ends of said elongated roll over the edges of said crab mixture to form a pastry enclosure for said crab mixture;
Sealing the edges of said pastry enclosure using egg wash; and
refrigerating said pastry enclosures containing said crab mixture.

2. A method according to claim 1, wherein said individual uncooked dough segments are substantially equal in shape and thickness.

3. A method according to claim 1, wherein said uncooked pastry dough comprises pastry puff dough.

4. A method according to claim 1, wherein said step of forming said elongated roll leaves about 1-1½ inches of uncooked pastry dough on each end of said elongated roll.

5. A method according to claim 1, wherein said thin, flat uncooked dough has a uniform thickness of about 1/32 inches.

6. A method according to claim 1, wherein each of said dough segments are formed by cutting said thin flat substrate into a plurality of squares and dividing each square into two pieces.

7. A method according to claim 1, wherein said crab meat mixture comprises crab meat, claw meat, backfin crab meat, cracker meal, bread crumbs, eggs, mayonnaise, dry mustard, parsley, Old Bay seasoning and corn flour.

8. A method according to claim 1, further comprising frying said pastry enclosures containing said crab meat mixture in a deep fryer.

9. A method according to claim 8, wherein said frying step takes place at a temperature of about 350 degrees F. for a period of about three minutes.

10. A method according to claim 1, further comprising baking said pastry enclosures containing said crab meat mixture for about 20 minutes at about 400 degrees F.

11. An edible food product based on crabmeat, comprising a thin-walled pastry shell containing a cooked crab meat mixture disposed fully inside said pastry shell, said crab meat mixture consisting essentially of crab meat, claw meat, backfin crab meat, bread crumbs, eggs, mayonnaise, dry mustard, parsley, Old Bay seasoning and corn flour and said pastry shell having a thickness of about 1/32 inches.
